(19) United States
(12) Patent Application Publication
(10) Pub. No.: US 2025/0025952 A1
(43) Pub. Date: Jan. 23, 2025

(54) POWER SUPPLY ABUTTING DEVICE AND THE EXECUTED CONTROL METHOD THEREOF

(71) Applicant: SUPER POWER TOOLS CO., LTD., Taichung City (TW)

(72) Inventor: Yu-Chun LIU, Taichung City (TW)

(21) Appl. No.: 18/353,795

(22) Filed: Jul. 17, 2023

(51) Int. Cl. B23D 59/00

(52) U.S. Cl. CPC B23D 59/001; B23D 59/006; B23D 59/008

(57) ABSTRACT

A power supply abutting device and the executed control method thereof. The power supply abutting device is used for connecting a woodworking cutting machine and a dust collector, and it controls the dust collector in combination with the woodworking cutting machine. The device includes a sensor and a controller, wherein the sensor is used for sensing the current of the power supplied from a first power source to the woodworking cutting machine, the controller judges whether the first power source supplies working current to the woodworking cutting machine based on the current, and controls the dust collector to start or stop operation in combination with the woodworking cutting machine without manual judgment and operation, and the sensor and the controller transmit signals in wireless mode.

### CROSS-REFERENCE TO RELATED U.S. APPLICATIONS

Not applicable.

### BACKGROUND OF THE INVENTION

### 1. Field of the Invention

The present invention relates generally to a device for controlling the operation of a woodworking cutting machine and a dust collector, and more particularly to a power supply abutting device and the executed control method thereof.

### 2. Description of Related Art Including Information Disclosed Under 37 CFR 1.97 and 37 CFR 1.98

In the process of wood cutting, when using woodworking cutting machines such as circular sawing machines, band-sawing machines and wood planing machines, the tissue of the wood is damaged by the cutting tool to form the dust of fine particles, the dust diffuses in the air and is likely to cause allergy of respiratory tract, eyes and skin. If the dust accumulates in the environment, it has a potential hazard of dust explosion. The dust collector can be used for collecting the dust resulted from the wood processing of the woodworking cutting machine, so as to avoid the dust diffusing in the air or accumulating in the environment.

The woodworking cutting machine often performs cutting operations intermittently, and long-term continuous operation is not required. The interval between two cutting operations changes in length. In a long interval, the operation of the woodworking cutting machine is stopped to reduce the noise in the working space and the power consumption, and to avoid the running cutting tool causing potential safety hazards, especially when the worker has to leave the woodworking cutting machine, the operation of the woodworking cutting machine must be stopped.

The dust collector needs to be shut down in good time while the woodworking cutting machine is shut down. Based on the motion path arrangement of personnel or materials, the woodworking cutting machine and the dust collector are not arranged side by side in the working space in general. At the beginning and end of the cutting process, the worker needs to move between the woodworking cutting machine and the dust collector to actuate or shut down the woodworking cutting machine and the dust collector. If the worker moves between the woodworking cutting machine and the dust collector many times during a complete working period, the working efficiency is influenced.

In the case of multiple woodworking cutting machines used for the working process respectively, it is optional to provide one dust collector with multiple dust collecting channels corresponding to the woodworking cutting machines. The dust collector collects the dust resulted from the wood processing of the woodworking cutting machines respectively through the dust collecting channels. The dust collector needs to be actuated when any of the woodworking cutting machines is actuated. The dust collector cannot be shut down until all of the woodworking cutting machines are shut down.

When one woodworking cutting machine is provided with one dust collector, a conventional linked switch can be selected. The linked switch is electrically connected to a power source, while the power cords for importing power of the woodworking cutting machine and the dust collector are electrically connected to the linked switch respectively. The power supply to the woodworking cutting machine and the dust collector can be controlled synchronously by operating the linked switch, so as to start or stop the operation of the woodworking cutting machine and the dust collector synchronously. However, the woodworking cutting machine and the dust collector are not arranged side by side in the working space in general, the power source connected to the linked switch is usually far away from the woodworking cutting machine or the dust collector. The power cords of the woodworking cutting machine and the dust collector are likely to complicate the wiring in the working space.

In the case of multiple woodworking cutting machines provided with one dust collector, the linked switch can be used to synchronously control the power supply to multiple woodworking cutting machines and the dust collector. However, the power cords of the multiple woodworking cutting machines are electrically connected to the same the linked switch, the wiring in the working space is more complex, that is adverse to the arrangement of motion paths for the workers and materials.

When multiple workers need to use multiple woodworking cutting machines for processing operations in the working space, the workers seldom start and end the processing operations at the same time. If the woodworking cutting machines are actuated and shut down successively, a situation is likely to occur that the linked switch is switched off by other workers by mistake while some worker is still performing processing operation, and each worker believes that the linked switch will be switched off by other workers, so that the linked switch will not be switched off.

### BRIEF SUMMARY OF THE INVENTION

The primary object of the present invention is to provide a power supply abutting device and the executed control method thereof, which can control the power supply to a woodworking cutting machine and a dust collector.

The present invention is a power supply abutting device used for connecting a woodworking cutting machine and a dust collector, so as to control the dust collector in combination with the woodworking cutting machine. The device includes a sensor, including a first input port, a first output port, a sensing module, a first microprocessor and a wireless signal transmitting module. The first input port is used for electrically connecting a first power source. The first output port is used for electrically connecting the woodworking cutting machine. The first input port, the sensing module and the first output port are connected in series. The sensing module is located between the first input port and the first output port. The first power source supplies power to the woodworking cutting machine through the sensor. The first microprocessor is electrically connected to the sensing module and the wireless signal transmitting module. The sensing module is used for sensing the current passing through the first input port and the first output port. The first microprocessor judges the current, and controls the wireless signal transmitting module to send the first signal or second signal.

The device also includes a controller having a second input port, a second output port, apower switch, a second microprocessor and a wireless signal receiving module. The second input port is used for electrically connecting a second power source. The second output port is used for electrically connecting the dust collector. The second input port, the power switch and the second output port are connected in series, and the power switch is located between the second input port and the second output port. The power switch controls the circuit on-off state between the second power source and the dust collector. The second microprocessor is electrically connected to the power switch and the wireless signal receiving module. The wireless signal receiving module is used for receiving the first signal and the second signal. The second microprocessor performs counting and comparison based on the first signal and the second signal, and controls the on-off state of the power switch according to the comparison result.

The executed control method of said power supply abutting device includes the following steps:
sensing current: the sensing module senses the current of the power transmitted from the first power source to the woodworking cutting machine through the sensor;
comparison: the first microprocessor checks whether the current is larger than the preset first current, and whether the current is smaller than the preset second current;
sending signals: if the current is larger than the first current, the wireless signal transmitter transmits the first signal, if the current is smaller than the second current, the wireless signal transmitter transmits the second signal;
receiving signals: the wireless signal receiving module receives the first signal and the second signal;
counting: the second microprocessor calculates the cumulative number of the first signals and the cumulative number of the second signals respectively;
comparison and judgment: the second microprocessor checks whether the cumulative number of the first signals is identical with the cumulative number of the second signals, so as to judge the operating state of the woodworking cutting machine;
control: based on the same cumulative number of the first signals and the second signals, and the power switch is in on state, the second microprocessor controls the power switch to be in off state, based on the same cumulative number of the first signals and the second signals, and the power switch is in off state, the second microprocessor controls the power switch to remain in off state; based on different cumulative numbers of the first signals and the second signals, and the power switch is in off state, the second microprocessor controls the power switch to be in on state, based on different cumulative numbers of the first signals and the second signals, and the power switch is in on state, the second microprocessor controls the power switch to remain in on state.

The present invention can control the dust collector to start or stop operation according to the operating state and stop state of the woodworking cutting machine. It does not depend on the worker's manual judgment and operation. The sensor and the controller perform wireless signal transmission, the locations of the woodworking cutting machine and the dust collector in the space can be arranged according to the personnel and material motion paths, solving the wiring problem in prior art.

### BRIEF DESCRIPTION OF THE SEVERAL VIEWS OF THE DRAWINGS

FIG. 1 is a block diagram of the circuit in the Embodiment 1 of the present invention.

FIG. 2 is an actuation flow chart of the sensor in the Embodiment 1 of the present invention.

FIG. 3 is an actuation flow chart of the controller in the Embodiment 1 of the present invention.

FIG. 4 is a circuit block diagram of the sensor in the Embodiment 2 of the present invention.

### DETAILED DESCRIPTION OF THE INVENTION

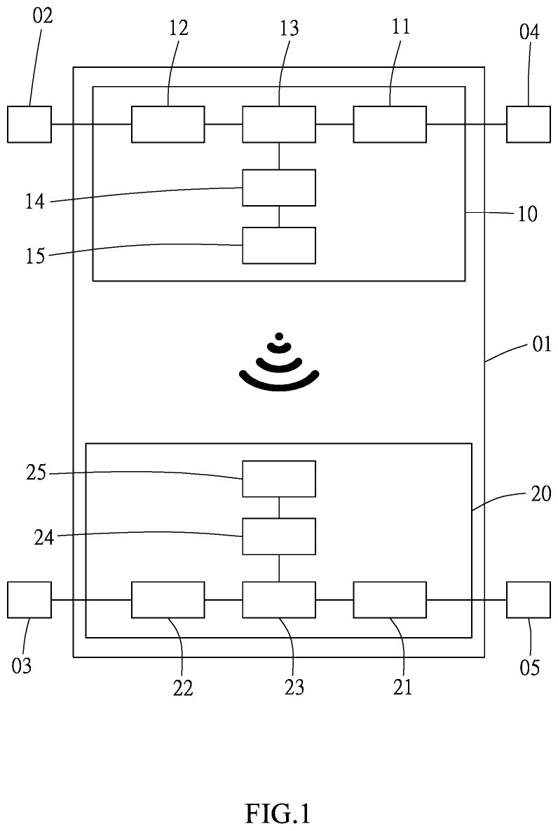

FIG. 1 to FIG. 3 show the Embodiment 1 of the power supply abutting device and the executed control method thereof of the present invention. Said power supply abutting device 01 is used for connecting a woodworking cutting machine 02 and a dust collector 03, so as to control the dust collector 03 in combination with the woodworking cutting machine 02.

The power supply abutting device 01 includes a sensor 10 and a controller 20, wherein the sensor 10 includes a first input port 11, a first output port 12, a sensing module 13, a first microprocessor 14 and a wireless signal transmitting module 15. The first input port 11 is used for electrically connecting a first power source 04. The first output port 12 is used for electrically connecting the woodworking cutting machine 02. The first input port 11, the sensing module 13 and the first output port 12 are connected in series, and the sensing module 13 is located between the first input port 11 and the first output port 12. The first power source 04 supplies power to the woodworking cutting machine 02 through the sensor 10. The first microprocessor 14 is electrically connected to the sensing module 13 and the wireless signal transmitting module 15. The sensing module 13 is used for sensing the current passing through the first input port 11 and the first output port 12. The first microprocessor 14 judges the current, and controls the wireless signal transmitting module 15 to send a first signal or a second signal according to the judgment result.

The controller 20 includes a second input port 21, a second output port 22, a power switch 23, a second microprocessor 24 and a wireless signal receiving module 25, wherein the second input port 21 is used for electrically connecting a second power source 05, and the second output port 22 is used for electrically connecting the dust collector 03. The second input port 21, the power switch 23 and the second output port 22 are connected in series, and the power switch 23 is located between the second input port 21 and the second output port 22. The power switch 23 controls the circuit on-off state between the second power source 05 and the dust collector 03. The second microprocessor 24 is electrically connected to the power switch 23 and the wireless signal receiving module 25, the wireless signal receiving module 25 is used for receiving the first signal and the second signal, the second microprocessor 24 performs counting and comparison based on the first signal and the second signal, and controls the on-off state of the power switch 23 according to the comparison result.

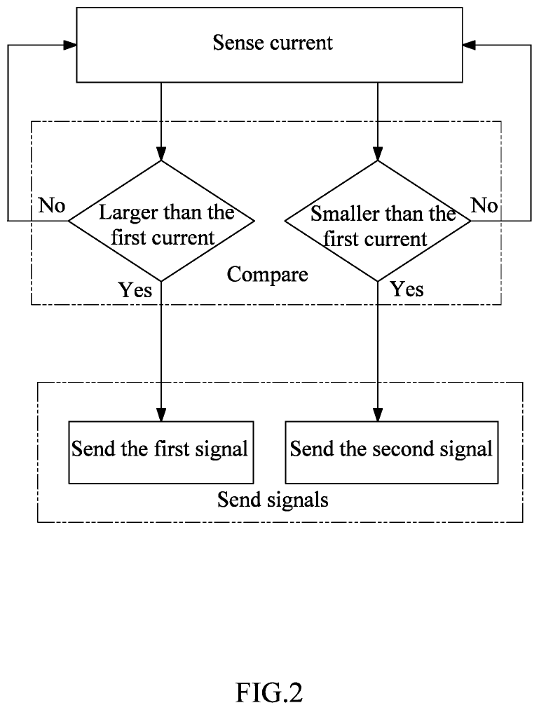

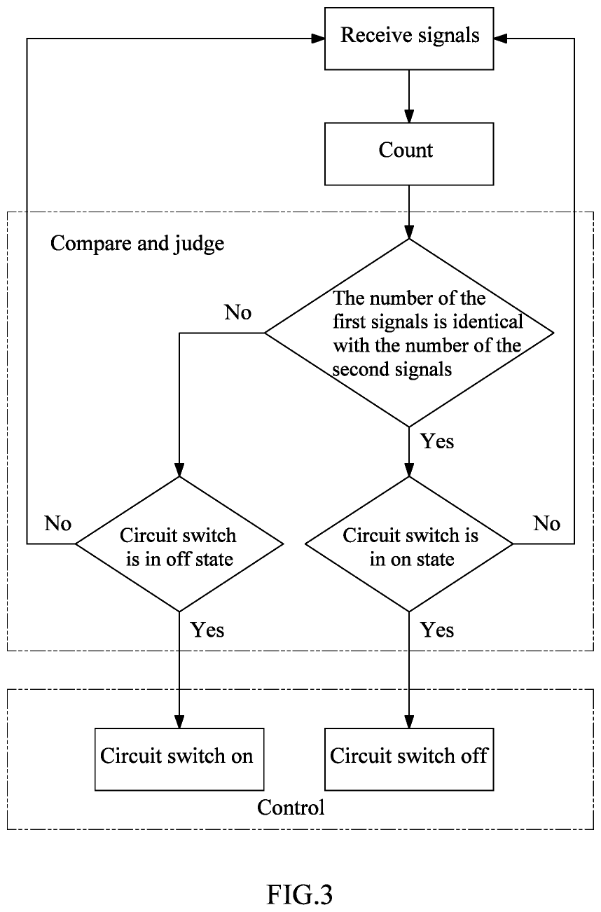

FIG. 2 and FIG. 3 show the executed control method of the power supply abutting device 01 includes the following steps:

Sensing current: the sensing module 13 senses the current of the power transmitted from the first power source 04 to the woodworking cutting machine 02 through the sensor 10.

Comparison: the first microprocessor 14 checks whether the current is larger than the preset first current, and whether the current is smaller than the preset second current.

The first current is determined by the value of the current transmitted by the first power source 04 to the woodworking cutting machine 02 through the sensor 10 when the woodworking cutting machine 02 is in operating state. The first current does not represent the current demand value of the woodworking cutting machine 02 during operation, if the current is higher than the first current, meaning the woodworking cutting machine 02 is in operating state. In this case, the first current is 5 A.

The second current is determined by the value of the current delivered from the first power source 04 to the woodworking cutting machine 02 through the sensor 10 when the woodworking cutting machine 02 is in stop state under the precondition that the first input port 11 is electrically connected to the first power source 04, and the first output port 12 is electrically connected to the woodworking cutting machine 02, and the second current is smaller than the first current, if the current is lower than the second current, meaning the woodworking cutting machine 02 is in stop state. In this case, the second current is 0.2-0.4 A.

Sending signals: if the current is larger than the first current, the first microprocessor 14 controls the wireless signal transmitter 15 to transmit the first signal, if the current is smaller than the second current, the first microprocessor 14 controls the wireless signal transmitter 15 to transmit the second signal.

Receiving signals: the wireless signal receiving module 25 receives the first signal and the second signal.

Counting: the second microprocessor 24 calculates the cumulative number of the first signals received and the cumulative number of the second signals respectively.

Comparison and judgment: the second microprocessor 24 checks whether the cumulative number of the first signals is identical with the cumulative number of the second signals, so as to judge the operating state of the woodworking cutting machine 02.

The operation cannot be stopped until the woodworking cutting machine 02 is actuated, the second signal cannot be sent out until the first signal is sent by the sensor 10, the cumulative number of the first signals is larger than or equal to the cumulative number of the second signals, the cumulative number of the first signals is larger than the cumulative number of the second signals, meaning the woodworking cutting machine 02 is in operating state. The cumulative number of the first signals is equal to the cumulative number of the second signals, meaning the woodworking cutting machine 02 is in stop state.

Control: based on the same cumulative number of the first signals and the second signals, and the power switch 23 is in on state, the second microprocessor 24 controls the power switch 23 to be in off state, so that the dust collector 03 changes from operating state to stop state. Based on the same cumulative number of the first signals and the second signals, and the power switch 23 is in off state, the second microprocessor 24 controls the power switch 23 to remain in off state, the dust collector 03 remains stopped. Based on different cumulative numbers of the first signals and the second signals, and the power switch 23 is in off state, the second microprocessor 24 controls the power switch 23 to be in on state, so that the dust collector 03 starts operation from stop state. Based on different cumulative numbers of the first signals and the second signals, and the power switch 23 is in on state, the second microprocessor 24 controls the power switch 23 to remain in on state, and the dust collector 03 remains in operation.

The present invention can judge the operating state and stop state of the woodworking cutting machine 02 according to the changes in the current of the power supplied from the first power source 04 to the woodworking cutting machine 02, and control the dust collector 03 to start or stop operation. It does not depend on the worker's manual judgment and operation, and the first signal and the second signal are transmitted in wireless mode between the sensor 10 and the controller 20. It is unnecessary to connect the power cords (not shown in the figure) of the woodworking cutting machine 02 and the dust collector 03 to the linked switch stated in prior art. The locations of the woodworking cutting machine 02 and the dust collector 03 in the space can be arranged according to the personnel and material motion paths, solving the wiring problem in prior art.

In the comparison and judgment step, it is optional to further judge whether the power switch 23 is in on state based on the same cumulative number of the first signals and the second signals, and to judge whether the power switch 23 is in on state based on different cumulative numbers of the first signals and the second signals, so as to execute the control step.

The controller 20 can replace the power supply module of the dust collector 03 as a component of the dust collector 03, and the controller 20 can be a component independent of the dust collector 03.

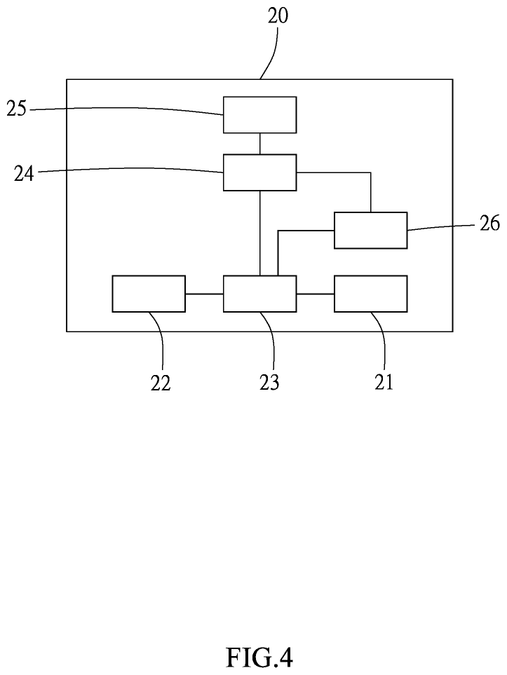

As shown in FIG. 4, the main difference of the Embodiment 2 from the Embodiment 1 is that the controller 20 includes a delay circuit 26, the delay circuit 26 is electrically connected to the second microprocessor 24 and the power switch 23, and the delay circuit 26 is located between the second microprocessor 24 and the power switch 23, so that the second microprocessor 24 and the power switch 23 form a two-circuit architecture, the second microprocessor 24 controls the actuation of the power switch 23 through the delay circuit 26 to form an open circuit.

Based on the same cumulative number of the first signals and the second signals, and the power switch 23 is in on state, the second microprocessor 24 controls the power switch 23 to become an open circuit after the preset delay time through the delay circuit 26. Based on different cumulative numbers of the first signals and the second signals, and the power switch 23 is in off state, the second microprocessor 24 directly controls the power switch 23 to be in on state without the delay circuit 26, so that the dust collector 03 starts operation from stop state.

After the power switch of the woodworking cutting machine 02 is switched off by the worker, after a length of preset delay time, the controller 20 controls the dust collector 03 to stop running. After the wood cutting operation is stopped, the dust collector 03 still pumps dust continuously during the delay time. When the worker turns on the power switch, the controller 20 controls the dust collector 03 to work instantly.

The Embodiment 1 and Embodiment 2 can contain several sensors 10 respectively, forming changed embodiments. In the case of multiple woodworking cutting machines 02 provided with one dust collector 03, the sensors 10 are configured on the woodworking cutting machines 02 respectively, and the sensors 10 correspond to one controller 20 respectively. The changed embodiments can control the dust collector 03 to start operation when at least one woodworking cutting machine 02 is actuated, the dust collector 03 stops running until each woodworking cutting machine 02 is shut down.

I claim:

1. A power supply abutting device, for connecting the woodworking cutting machine and the dust collector, controls the dust collector in combination with the woodworking cutting machine, including:
a sensor, including a first input port, a first output port, a sensing module, a first microprocessor and a wireless signal transmitting module, wherein the first input port is used for electrically connecting a first power source, the first output port is used for electrically connecting the woodworking cutting machine, the first input port, the sensing module and the first output port are connected in series, the sensing module is located between the first input port and the first output port, the first power source supplies power to the woodworking cutting machine through the sensor, the first microprocessor is electrically connected to the sensing module and the wireless signal transmitting module, the sensing module is used for sensing the current passing through the first input port and the first output port, the first microprocessor judges the current, and controls the wireless signal transmitting module to send the first signal or second signal; and
a controller, including a second input port, a second output port, a power switch, a second microprocessor and a wireless signal receiving module, wherein the second input port is used for electrically connecting a second power source, the second output port is used for electrically connecting the dust collector, the second input port, the power switch and the second output port are connected in series, and the power switch is located between the second input port and the second output port, the power switch controls the circuit on-off state between the second power source and the dust collector, the second microprocessor is electrically connected to the power switch and the wireless signal receiving module, the wireless signal receiving module is used for receiving the first signal and the second signal, the second microprocessor performs counting and comparison based on the first signal and the second signal, and controls the on-off state of the power switch according to the comparison result.

2. The power supply abutting device defined in claim 1, wherein the controller includes a delay circuit, the delay circuit is electrically connected to the second microprocessor and the power switch, and the delay circuit is located between the second microprocessor and the power switch, so that the second microprocessor and the power switch form a two-circuit architecture, the second microprocessor controls the actuation of the power switch through the delay circuit to form an open circuit.

3. An executed control method of the power supply abutting device defined in claim 1, including the following steps:
sensing current: the sensing module senses the current of the power transmitted from the first power source to the woodworking cutting machine through the sensor;
comparison: the first microprocessor checks whether the current is larger than the preset first current, and whether the current is smaller than the preset second current;
sending signals: if the current is larger than the first current, the wireless signal transmitter transmits the first signal, if the current is smaller than the second current, the wireless signal transmitter transmits the second signal;
receiving signals: the wireless signal receiving module receives the first signal and the second signal;
counting: the second microprocessor calculates the cumulative number of the first signals and the cumulative number of the second signals respectively;
comparison and judgment: the second microprocessor checks whether the cumulative number of the first signals is identical with the cumulative number of the second signals, so as to judge the operating state of the woodworking cutting machine;
control: based on the same cumulative number of the first signals and the second signals, and the power switch is in on state, the second microprocessor controls the power switch to be in off state, based on the same cumulative number of the first signals and the second signals, and the power switch is in off state, the second microprocessor controls the power switch to remain in off state; based on different cumulative numbers of the first signals and the second signals, and the power switch is in off state, the second microprocessor controls the power switch to be in on state, based on different cumulative numbers of the first signals and the second signals, and the power switch is in on state, the second microprocessor controls the power switch to remain in on state.

4. The executed control method of the power supply abutting device defined in claim 3, whether the power switch is in on state is judged based on the same cumulative number of the first signals and the second signals, and whether the power switch is in on state is judged based on different cumulative numbers of the first signals and the second signals, so as to execute the control step.

5. The executed control method of the power supply abutting device defined in claim 3, wherein the first current is 5 A, the second current is 0.2-0.4 A.
